(19) United States
(12) Patent Application Publication
(10) Pub. No.: US 2014/0346164 A1
(43) Pub. Date: Nov. 27, 2014

(54) HIGH FREQUENCY INDUCTION CONTINUOUS HEATING METHOD AND HIGH FREQUENCY INDUCTION CONTINUOUS HEATING APPARATUS

(71) Applicant: Denki Kogyo Company, Limited, Tokyo (JP)

(72) Inventors: Kouichi Miyashita, Tokyo (JP); Toshiyuki Sakuma, Tokyo (JP); Akira Suenaga, Tokyo (JP)

(21) Appl. No.: 14/373,698

(22) PCT Filed: Dec. 20, 2012
(86) PCT No.: PCT/JP2012/083044

§ 371 Date: Jul. 22, 2014

(30) Foreign Application Priority Data
Jan. 27, 2012 (JP) 2012-015162

(51) Int. Cl. H05B 6/10; C21D 1/42

(52) U.S. Cl. CPC H05B 6/102; C21D 1/42
USPC 219/652

(57) ABSTRACT

A high frequency induction continuous heating method and a high frequency induction continuous heating apparatus are provided, and they can improve a working efficiency of a heating treatment and can also improve an uniformity of the heating treatment for an entirety of a work piece corresponding to multiple types of work pieces. In the high frequency induction continuous heating method in which a work piece (W) placed on a conveyance surface (2a) of a conveyor (2) is conveyed, and the work piece (W) on the conveyance surface (2a) is heated by high frequency induction heating coils (3) which are disposed at both ends of the conveyor (2) in a crosswise direction perpendicular to a conveyance direction (shown by an arrow (D) in the drawing), the work piece (W) is rotated around an axis which is extended so as to be perpendicular to the conveyance surface (2a), at a certain rotation angle (A) in mid-flow of the conveyance of the work piece (W) to change an orientation of the work piece (W). The high frequency induction continuous heating apparatus (1) uses the above-described method.

### TECHNICAL FIELD

The present invention relates to a high frequency induction continuous heating method and to a high frequency induction continuous heating apparatus for heating a work piece to be heated.

### BACKGROUND ART

Typically, a heating treatment is applied to a work piece to be heated, such as a steel member or the like (hereinafter referred to as a “work piece”) during quenching for hardening the work piece, and furthermore, the heating treatment is also practiced during tempering for providing toughness to the quenched work piece. In particular, in the tempering operation, a slow cooling treatment is practiced after the heating treatment is applied to the quenched work piece during a specific time period.

To practice the heating treatment in the tempering operation or the like, a continuous heating method and a continuous heating apparatus have been used conventionally and widely, and they are characterized in heating a work piece continuously by a heating element, such as a burner, a high frequency heating coil, or the like while conveying the work piece by a conveyor. For example, as disclosed in Patent Literature 1, a work piece which is placed on a conveyance surface of a conveyor having a specific length, is conveyed. The conveying work piece is heated by heating elements that are disposed at both ends of the conveyor in a crosswise direction perpendicular to a conveyance direction (this perpendicular direction will be hereinafter simply referred to as a “crosswise direction”).

In particular, regarding the high frequency induction continuous heating method and the high frequency induction continuous heating apparatus which use a high frequency induction heating coil (hereinafter simply referred to as a “heating coil”) as the heating element, in a case in which the heating treatment is applied to multiple types of work pieces having different dimensions or the like, positions of the heating elements are adjusted such that a distance between the work piece and the heating element is kept constant.

### CITATION LIST

### Patent Literature

[Patent Literature 1] Japanese Patent Application Laid-Open No. 2004-043909

### SUMMARY OF INVENTION

### Technical Problem

However, regarding the conventional high frequency induction continuous heating method and the high frequency induction continuous heating apparatus, in a case in which: a distance h1 is set between an end of a first work piece A in the crosswise direction and a heating coil 11, and it has a maximum external dimension of diameter d1 from a planar view as shown in FIG. 6A; a distance h2 is set between an end of a second work piece B in the crosswise direction and the heating coil 11, and it has a maximum external dimension of diameter d2 larger than the diameter d1 from a planar view as shown in FIG. 6B; a distance 11 is set between the center of the smaller first work piece A in the crosswise direction and the heating coil 11; and a distance 12 is set between the center of the larger second work piece B in the crosswise direction and the heating coil 11, if the distance h1 is the same as the distance h2, the distance 12 becomes larger than the distance 11. In this case, a time period for transmitting heat from the end of the second work piece B in the crosswise direction to the center thereof in the crosswise direction, becomes longer than a time period for transmitting heat from the end of the first work piece A in the crosswise direction to the center thereof in the crosswise direction. As a result, if a heating time period for the second work piece B is set in the same manner as a heating time period for the first work piece A, an entirety of the second work piece B is heated so as to be less uniform than an entirety of the first work piece A. Therefore, quality of the second work piece B becomes lower than that of the first work piece A in view of uniformity of the heating treatment for the entirety of the work piece.

In addition, regarding the conventional continuous heating method and the continuous heating apparatus, in a case in which the heating treatment is applied to multiple types of work pieces on the same continuous heating apparatus, that is to say, for example, in a case such as is shown in FIGS. 7A and 7B, each of a smaller first work piece A shown in FIG. 7A and a larger work piece B shown in FIG. 7B is separately placed on a conveyance surface 22a of a conveyor 22 in the same continuous heating apparatus 21, and the heating treatment is applied to both the smaller work piece A and the larger work piece B by a heating element 23, it is necessary to control such that a clearance between mutually adjacent smaller first work pieces A is the same as a clearance between mutually adjacent larger second work pieces B. However, a length L of the conveyor 22 of the continuous heating apparatus 21 is fixed. Therefore, numbers of the second work pieces B which can be placed on the conveyance surface 22a of the conveyor 22 at the same time (six pieces in FIG. 7B) become smaller than numbers of the first work pieces A which can be placed in the similar manner (eight pieces in FIG. 7A). As a result, if the conveyance speed for the first work pieces A and that for the second work pieces B are set in the same manner, numbers of the second work pieces B which can be heated within a certain time period become less than numbers of the first work pieces A which can be heated in the similar manner. Accordingly, a working efficiency for applying the heating treatment to the second work pieces B become lower than that for applying the heating treatment to the first work pieces A. On the other hand, if the conveyance speed for the second work pieces B is set higher than that for the first work pieces A so that numbers of the second work pieces B which can be heated within a certain time period become the same as numbers of the first work pieces A, the heating time period for the second work pieces B becomes shorter than that for the first work pieces A. Accordingly, the entirety of the second work piece B is heated in a far less uniform way than the entirety of the first work piece A, and therefore, quality of the second work piece B becomes far lower than that of the first work piece A in view of the uniformity of the heating treatment for the entirety of the work piece.

The present invention has been completed in consideration of the above situations, and a purpose of the present invention is to provide a high frequency induction continuous heating method and a high frequency induction continuous heating apparatus which can enhance a working efficiency of a heating treatment and can also enhance uniformity of the heating treatment for an entirety of a work piece corresponding to multiple types of work pieces.

### Solution to Problem

To solve the above-described problem, regarding a high frequency induction continuous heating method according to an aspect of the present invention, a work piece placed on a conveyance surface of a conveyor is conveyed, and the work piece on the conveyance surface is heated by high frequency induction heating coils which are disposed at both ends of the conveyor in a crosswise direction perpendicular to a conveyance direction, the method includes a step of: rotating the work piece around an axis which is extended so as to be perpendicular to the conveyance surface, at a certain rotation angle in mid-flow of conveyance of the work piece so that an orientation of the work piece is changed.

Regarding the high frequency induction continuous heating method according to an aspect of the present invention further includes steps of: stopping the conveyance of the work piece before the work piece rotating step; and resuming the conveyance of the work piece after the work piece rotating step.

Regarding the high frequency induction continuous heating method according to an aspect of the present invention, in the work piece rotating step, the work piece is lifted from the conveyance surface, the lifted work piece is rotated, and the rotated work piece is placed on the conveyance surface.

Regarding the high frequency induction continuous heating method according to an aspect of the present invention, in the work piece rotating step, if a rotational center of the rotated work piece has been shifted in a horizontal direction from a reference position which corresponds to the rotational center of the work piece in a state before being lifted, the rotated work piece is moved in the horizontal direction so as to align the rotational center of the rotated work piece with the reference position.

The high frequency induction continuous heating method according to an aspect of the present invention further includes a step of: adjusting the rotation angle of the work piece before the work piece rotating step.

To solve the above-described problem, a high frequency induction continuous heating apparatus according to an aspect of the present invention includes: a conveyance surface on which a work piece is placed; a conveyor configured to convey the work piece on the conveyance surface; high frequency induction heating coils disposed at both ends of the conveyor in a crosswise direction perpendicular to a conveyance direction, and configured to heat the work piece on the conveyance surface; and a work piece rotating mechanism configured so as to rotate the work piece around an axis which is extended so as to be perpendicular to the conveyance surface, at a certain rotation angle in mid-flow of conveyance of the work piece so that an orientation of the work piece is changed.

Regarding the high frequency induction continuous heating apparatus according to an aspect of the present invention, after the work piece is rotated by the work piece rotating mechanism in a state in which the conveyance of the work piece has been stopped, the conveyance of the rotated work piece is resumed.

Regarding the high frequency induction continuous heating apparatus according to an aspect of the present invention, the work piece rotating mechanism is configured so as to lift the work piece from the conveyance surface, rotate the lifted work piece, and place the rotated work piece on the conveyance surface.

Regarding the high frequency induction continuous heating apparatus according to an aspect of the present invention, the work piece rotating mechanism is configured such that if a rotational center of the rotated work piece has been shifted in a horizontal direction from a reference position which corresponds to the rotational center of the work piece in a state before being lifted, the rotated work piece is moved in the horizontal direction so as to align the rotational center of the rotated work piece with the reference position.

Regarding the high frequency induction continuous heating apparatus according to an aspect of the present invention, the work piece rotating mechanism is configured so as to be capable of adjusting the rotation angle of the work piece.

### Advantageous Effects of Invention

The following advantageous effects can be obtained by a high frequency induction continuous heating method according to the present invention. Regarding the high frequency induction continuous heating method according to an aspect of the invention, a work piece placed on a conveyance surface of a conveyor is conveyed, and the work piece on the conveyance surface is heated by high frequency induction heating coils which are disposed at both ends of the conveyor in a crosswise direction perpendicular to a conveyance direction, the method includes a step of: rotating the work piece around an axis which is extended so as to be perpendicular to the conveyance surface, at a certain rotation angle in mid-flow of conveyance of the work piece so that an orientation of the work piece is changed. Therefore, the orientation of the work piece is changed across a timing of rotation of the work piece so that multiple portions of the work piece can come close to the high frequency induction heating coil, and thereby the entirety of the work piece can be heated uniformly in a short heating time period. In particular, in the larger work piece, the distance between the high frequency induction heating coil and the center of the work piece in the crosswise direction is increased, and therefore, multiple portions of the work piece can be moved close to the high frequency induction heating coil so that it is enabled to heat the entirety of the work piece uniformly in a short heating time period. Accordingly, a working efficiency of a heating treatment can be improved and uniformity of the heating treatment for the entirety of the work piece can also be improved corresponding to multiple types of work pieces.

The high frequency induction continuous heating method according to an aspect of the present invention further includes steps of: stopping the conveyance of the work piece before the work piece rotating step; and resuming the conveyance of the work piece after the work piece rotating step. In addition, in the work piece rotating step, the work piece is lifted from the conveyance surface, the lifted work piece is rotated, and the rotated work piece is placed on the conveyance surface. Therefore, the work piece can be rotated securely, and the working efficiency of the heating treatment can be improved.

Regarding the high frequency induction continuous heating method according to an aspect of the present invention, in the work piece rotating step, if a rotational center of the rotated work piece has been shifted in a horizontal direction from a reference position which corresponds to the rotational center of the work piece in a state before being lifted, the rotated work piece is moved in the horizontal direction so as to align the rotational center of the rotated work piece with the reference position. Accordingly, the rotational center of the work piece is kept at a constant position during heating, and thereby the uniformity of the heating treatment for the entirety of the work piece can be improved.

The high frequency induction continuous heating method according to an aspect of the present invention further includes a step of: adjusting the rotation angle of the work piece before the work piece rotating step. Accordingly, the uniformity of the heating treatment for the entirety of the work piece can be improved and the working efficiency of the heating treatment can also be improved corresponding to multiple types of work pieces or different heating time periods for the work pieces.

The following advantageous effects can be further obtained by a high frequency induction continuous heating apparatus according to the present invention. The high frequency induction continuous heating apparatus according to an aspect of the invention includes: a conveyance surface on which a work piece is placed, a conveyor configured to convey the work piece on the conveyance surface; high frequency induction heating coils disposed at both ends of the conveyor in a crosswise direction perpendicular to a conveyance direction, and configured to heat the work piece on the conveyance surface; and a work piece rotating mechanism configured to rotate the work piece around an axis which is extended so as to be perpendicular to the conveyance surface, at a certain rotation angle in mid-flow of conveyance of the work piece so that an orientation of the work piece is changed. Therefore, the orientation of the work piece is changed across the timing of rotation of the work piece so that multiple portions of the work piece can come close to the high frequency induction heating coil, and thereby the entirety of the work piece can be heated uniformly in a short heating time period. In particular, in the larger work piece, the distance between the high frequency induction heating coil and the center of the work piece in the crosswise direction is increased, and therefore, multiple portions of the work pieces can be moved close to the high frequency induction heating coil so that it is enabled to heat the entirety of the work piece uniformly in a short heating time period. Accordingly, a working efficiency of a heating treatment can be improved and uniformity of the heating treatment for the entirety of the work piece can also be improved corresponding to multiple types of work pieces.

Regarding the high frequency induction continuous heating apparatus according to an aspect of the present invention, after the work piece is rotated by the work piece rotating mechanism in a state in which the conveyance of the work piece has been stopped, the conveyance of the rotated work piece is resumed. In addition, the work piece rotating mechanism is configured to lift the work piece from the conveyance surface, rotate the lifted work piece, and place the rotated work piece on the conveyance surface. Therefore, the work piece can be rotated securely, and the working efficiency of the heating treatment can be improved.

Regarding the high frequency induction continuous heating apparatus according to an aspect of the present invention, the work piece rotating mechanism is configured such that if the rotational center of the rotated work piece has been shifted in the horizontal direction from the reference position which corresponds to the rotational center of the work piece in a state before being lifted, the rotated work piece is moved in the horizontal direction so as to align the rotational center of the rotated work piece with the reference position. Accordingly, the rotational center of the work piece is kept at a constant position during heating, and thereby the uniformity of the heating treatment for the entirety of the work piece can be improved.

Regarding the high frequency induction continuous heating apparatus according to an aspect of the present invention, the work piece rotating mechanism is configured so as to be capable of adjusting the rotation angle of the work piece. Accordingly, the uniformity of the heating treatment for the entirety of the work piece can be improved and the working efficiency of the heating treatment can also be improved corresponding to multiple types of work pieces or different heating time periods for the work pieces.

### BRIEF DESCRIPTION OF DRAWINGS

FIG. 1 is a front view showing a high frequency induction continuous heating apparatus according to a First Embodiment of the present invention in a state in which a high frequency induction heating coil is omitted.

FIG. 2A is a partial plan view showing a portion of the high frequency induction continuous heating apparatus according to the First Embodiment in a state in which a work piece has been placed, and FIG. 2B is a plan view showing a state in which the work piece of FIG. 2A is rotated at a certain rotation angle (90 degrees).

FIG. 3 is a diagram showing a relationship between temperature and time for respective first and second heated portions observed when the work pieces are heated by the high frequency induction continuous heating method according to the First Embodiment.

FIG. 4A is a cross sectional view of the work piece according to an Example of the present invention, the cross section view showing respective temperature measurement regions of the first and the second heated portions, and FIG. 4B is a cross sectional view of the work piece according to the Example of the present invention, the cross sectional view showing respective hardness measurement regions of the first and the second heated portions.

FIG. 5 is a view showing a hardness of the respective hardness measurement regions of the first and the second heated portions according to the Example.

FIG. 6A is a plan view showing a state in which multiple smaller work pieces are placed on a conveyor according to the conventional method, and FIG. 6B is a plan view showing a state in which multiple larger work pieces are placed on the conveyor according to the conventional method.

FIG. 7A is a plan view showing a portion of a high frequency induction continuous heating apparatus according to the conventional method in a state in which a smaller work piece is placed thereon, and FIG. 7B is a plan view showing a portion of a high frequency induction continuous heating apparatus according to the conventional method in a state in which a larger work is placed thereon.

### DESCRIPTION OF EMBODIMENTS

### First Embodiment

A high frequency induction continuous heating apparatus (hereinafter simply referred to as a “heating apparatus”) and a high frequency induction continuous heating method (hereinafter simply referred to as a “heating method”) according to a First Embodiment of the present invention will be explained below. As an example, in the First Embodiment, the heating apparatus and the heating method will be described as being used for tempering of a heated work piece (hereinafter simply referred to as a “work piece”); however, the heating apparatus and the heating method are not limited for use in tempering, and they may be used for quenching, annealing, normalizing, or the like of a work piece. In addition, in the First Embodiment, the work piece is explained such that it has a substantially conical shape as an example; however, the work piece according to the First Embodiment is not limited to this, and it may be a tempered member which has any other shape.

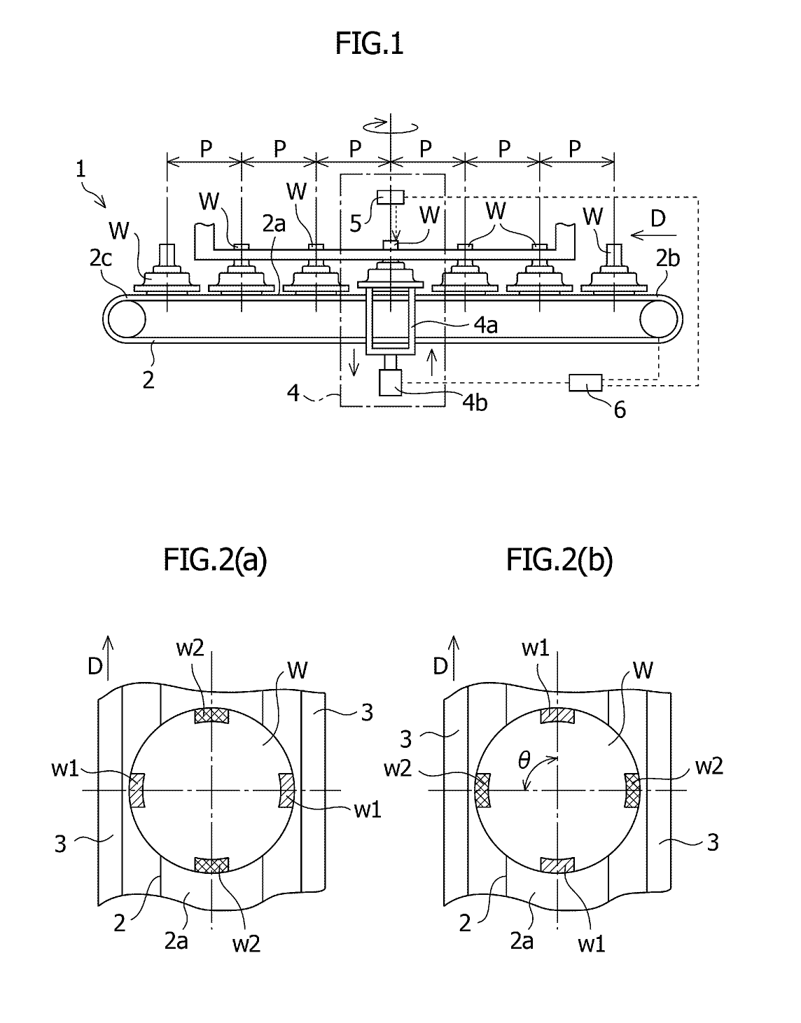

Referring to FIG. 1, a heating apparatus 1 includes a conveyor 2 which is configured so as to convey a work piece W. The conveyor 2 includes a conveyance surface 2a on which the work piece W can be placed. The conveyor 2 is configured such that the work pieces W can be conveyed at pitch intervals in a conveyance direction (shown by an arrow D). That is to say, the conveyor 2 is configured so that the work piece W is repeatedly conveyed by a distance P which is a certain pitch interval, the conveyance is then stopped, and the conveyance of the work piece W is resumed after stopping the conveyance for a certain time period. The present Embodiment is configured such that N (=2, 3, 4, . . . ) pieces of work pieces W can be placed on the conveyance surface 2a of the conveyor 2 described above at an interval of distance P, and the work piece W is conveyed from a leading end 2b of the conveyor to a trailing end 2c thereof at (N−1) pitch interval(s). As an example, the heating apparatus 1 shown in FIG. 1 is configured such that seven pieces of work pieces W can be placed on the conveyance surface 2a of the conveyor 2 at the interval of distance P among them, and the work piece W is conveyed from the leading end 2b of the conveyor in the longitudinal direction to the trailing end 2c thereof at six pitch intervals.

Referring to FIGS. 2A and 2B, the heating apparatus 1 includes high frequency induction heating coils (hereinafter simply referred to as “heating coils”) 3 which are disposed at both ends of the conveyor 2 in a direction perpendicular to the direction of conveyance of the work piece W (shown by the arrow D) (this perpendicular direction will be hereafter simply referred to as a “crosswise direction”). The heating coil 3 is configured so as to heat the work piece W on the conveyance surface 2a of the conveyor 2. The heating coil 3 is formed so as to extend along a longitudinal direction of the conveyor 2. A space is provided between the end of the conveyor 2 in the crosswise direction and the heating coil 3.

Referring to FIG. 1 again, the heating apparatus 1 includes a work piece rotating mechanism 4 that is disposed on the center of the conveyor 2 in the longitudinal direction. The work piece rotating mechanism 4 includes a holding portion 4a capable of holding the work piece W. Furthermore, the heating apparatus 1 includes a drive unit 4b which is configured to allow the holding portion 4a to rotate around an axis perpendicular to the conveyance surface 2a of the conveyor 2, allow the holding portion 4a to move in the vertical direction, and also allow the holding portion 4a to move in the horizontal direction. The drive unit 4b is disposed below the conveyor 2, the holding portion 4a is disposed on an upper end of the drive unit 4b, and therefore, the present Embodiment is configured such that the work piece W is held in the upper end of the holding portion 4a. In the First Embodiment, the rotation angle θ for the holding portion 4a is 90 degrees, and however, the rotation angle θ may be in the range of an angle greater than 0 degrees and an angle less than 180 degrees.

Referring to FIG. 1, the heating apparatus 1 includes a position sensor 5, and the position sensor 5 is configured to detect a horizontal position of the work piece W which is held by the holding portion 4a of the work piece rotating mechanism 4. The heating apparatus 1 includes a control device 6 which is connected to the conveyor 2, the drive unit 4b of the work piece rotating mechanism 4, and the position sensor 5.

A heating method for tempering the work piece W by using the heating apparatus 1 as the mentioned above will be explained. As shown in FIG. 1, the work piece W is placed on the conveyance surface 2a of the conveyor 2 at the leading end 2b. The work piece W placed on the conveyance surface 2a, is fed from the leading end 2b toward the trailing end 2c pitch by pitch while heating the work piece W by the heating coil 3 under control of the control device 6. In this step, the work piece W is conveyed by an amount equivalent to the certain distance P within a certain time period t1 in one pitch, and the conveyance of the work piece W is stopped for a certain time period t2 among the respective pitches.

In mid-flow of the conveyance described above, in a state in which the work piece W is stopped after it is conveyed by three pitches, the holding portion 4a of the work piece rotating mechanism 4 is allowed to move upward under control of the control device 5, the holding portion 4a of the work piece rotating mechanism 4 is allowed to protrude from the conveyance surface 2a through the space between the end of the conveyor 2 in the crosswise direction and the heating coil 3, the work piece W is held at the upper end of the holding portion 4a, and as a result, the held work piece W is lifted. The lifted work piece W is allowed to rotate around the axis which is extended toward the conveyance surface 2a of the conveyor 2, at 90 degrees (=the rotation angle θ) so as to change the orientation of the work piece W. In this step, if the position sensor 5 has detected any shift of the rotational center of the rotated work piece W from a reference position which corresponds to the rotational center of the work piece W being in a state before it is lifted, the control device 6 controls the drive unit 4b of the work piece rotating mechanism 4 based on a signal which is transmitted from the position sensor 5 to the control device 6, such that the rotated work piece W is moved in the horizontal direction so as to align the rotational center of the rotated work piece W with the reference position. The work piece W is then placed on the conveyance surface 2a of the conveyor 2 again, and the conveyance of the work piece W is resumed. The work piece W of which the conveyance has been resumed, is further conveyed by three pitches, the work piece W is conveyed over to the trailing end 2c of the conveyor 2, and then, it is brought out.

Operations achieved across the timing of rotation of the work piece W will be explained. As shown in FIG. 2A, before the work piece W is rotated, first heated portions w1 (shown in the drawing as single-hatch portions) of the work piece W, which are positioned at both ends thereof in the crosswise direction and on the center thereof in the conveyance direction, are arranged closest to the heating coil 3. On the other hand, second heated portions w2 (shown in the drawing as double-hatched portions), which are positioned on the center of the work piece W in the crosswise direction and at both ends thereof in the conveyance direction thereof, are positioned most distantly from the heating coil 3. In this state, heat generated from the heating coil 3 is easily transmitted to the first heated portions w1 but is hardly transmitted to the second heated portions w2. When the work piece W is rotated at 90 degrees as described above, after the rotation of the work piece W, the second heated portions w2 are positioned closest to the heating coil 3 while the first heated portions w1 are positioned most distantly from the heating coil as shown in FIG. 2B. In this state, heat generated from the heating coil 3 is easily transmitted to the second heated portions w2 but is hardly transmitted to the first heated portions w1. The work piece W is conveyed by three pitches in the state before the rotation and by as many pitches in the state after the rotation, and therefore, the time period for heating the work piece W in the state before the rotation becomes equal to the time period for heating the work piece W in the state after the rotation. Accordingly, the entirety of the work piece W is heated uniformly.

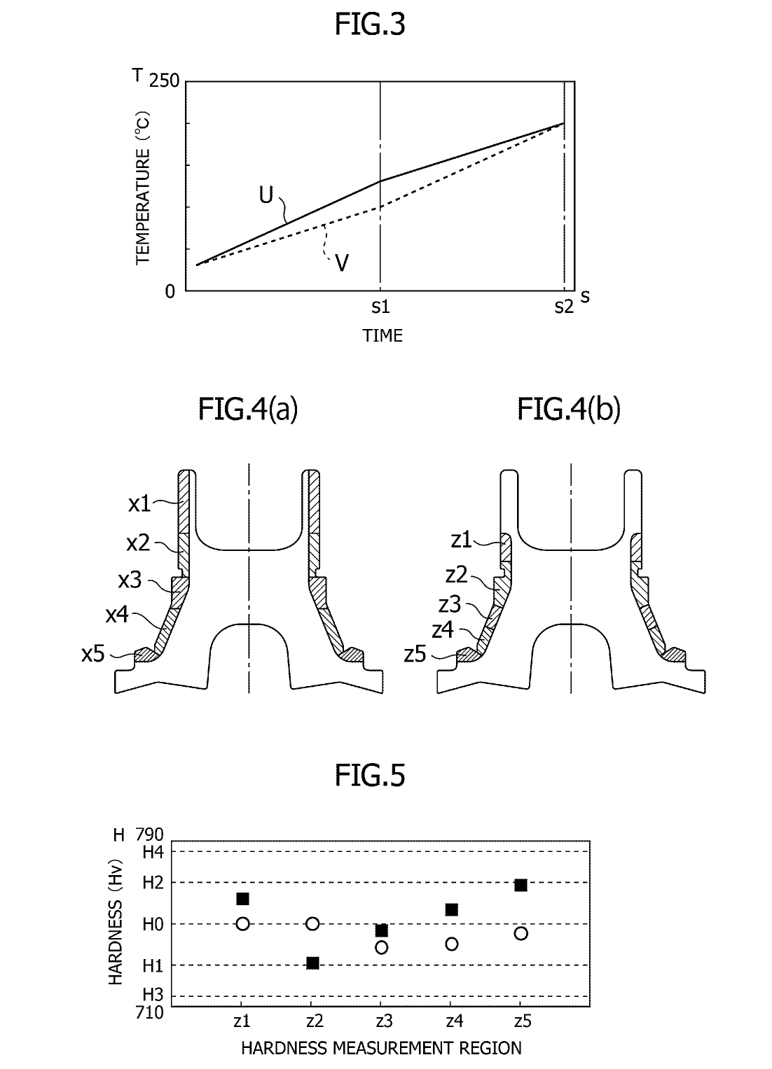

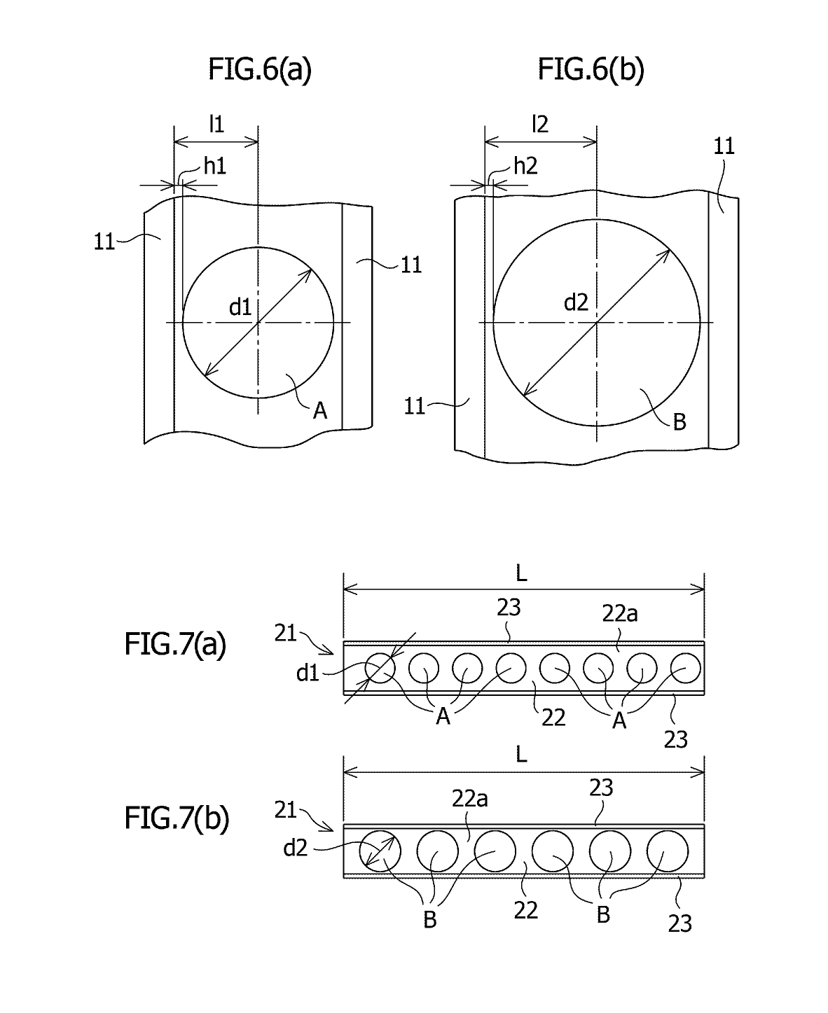

As a result, a relationship shown in FIG. 3 is achieved between a temperature T and time s with respect to the first heated portions w1 and the second heated portions w2. Referring to FIG. 3, before a timing s1 at which the work piece W is rotated, the temperature of the first heated portions which is shown by a solid line U, increases at a ratio higher than that for the second heated portions w2 which is shown by a broken line V, while after the timing s1 at which the work piece W is rotated, the temperature of the second heated portions w2 which is shown by the broken line V, increases at a ratio higher than that for the first heated portions w shown by the solid line U. At a timing s2 at which the conveyance of the work piece W ends, the temperature of the first heated portions w1 shown by the solid line U is equal to the temperature of the second heated portions w2 shown by the broken line V.

As described above, according to the First Embodiment, the orientation of the work piece W is changed across the timing of rotation of the work piece W so that multiple portions of the work piece W can come close to the heating coil 3, and thereby the entirety of the work piece W can be heated uniformly in a short heating time period. In particular, in the larger work piece W, the distance between the heating coil 3 and the center of the work piece W in the crosswise direction is increased, and therefore, multiple portions of the work piece W can be moved close to the high frequency induction heating coil so that it is enabled to uniformly heat the entirety of the work piece W in a short heating time period. Accordingly, the working efficiency of the heating treatment can be improved and the uniformity of the heating treatment for the entirety of the work piece W can also be improved corresponding to multiple types of work pieces W.

According to the First Embodiment, after the work piece W is rotated in the state in which the conveyance of the work piece W has been stopped, the conveyance of the work piece W is resumed. Furthermore, in rotating the work piece W, the work piece is lifted from the conveyance surface 2a of the conveyor 2, the lifted work piece W is rotated, and the rotated work piece W is placed on the conveyance surface 2a. Accordingly, the work piece W can be rotated securely, and the working efficiency of the heating treatment can be improved.

According to the First Embodiment, if the rotational center of the rotated work piece W has been shifted in the horizontal direction from the reference position which corresponds to the rotational center of the work piece W in a state before being lifted, the rotated work piece W is moved in the horizontal direction so as to align the rotational center of the rotated work piece W with the reference position. Accordingly, the rotational center of the work piece W is kept at a constant position during heating, and thereby the uniformity of the heating treatment for the entirety of the work piece W can be improved.

### Second Embodiment

A heating apparatus and a heating method according to a Second Embodiment of the present invention will be explained below. The heating apparatus and the heating method according to the Second Embodiment are basically similar to those according to the First Embodiment. Components and portions similar to those of the First Embodiment are provided with the same reference numerals and names as those of the First Embodiment in the following description. In the present Embodiment, configurations different from those of the First Embodiment will be described below.

In the present Embodiment, although not shown in the drawings, the heating apparatus 1 includes multiple work piece rotating mechanisms 4 which are disposed in the longitudinal direction of the conveyor 2 at intervals, and the present Embodiment is configured such that the rotation angle θ of the holding portion 4a which is rotated by the drive unit 4b, can be adjusted. With the above-described configuration, the present Embodiment is configured such that if the work piece W is to be rotated by i (=1, 2, 3, . . . ) piece(s) of the work piece rotating mechanism(s), the rotation angle θ of the holding portion 4a is set to (90/i) degrees. For example, if the work piece W is to be rotated by using two pieces of work piece rotating mechanisms 4, the rotation angle θ of the holding portion 4a may be set at 45 degrees. In addition, if the work piece W is to be rotated by using three pieces of work piece rotating mechanisms 4, the rotation angle θ of the holding portion 4a may be set at 30 degrees.

The method for heating the work piece W which uses the heating apparatus 1 described above and the workings achieved across the timing of rotation of the work piece W are similar to those of the First Embodiment.

As described above, according to the Second Embodiment, in addition to the effects similar to those of the First Embodiment achieved thereby, the heating time period for the work piece W can be further shortened for the larger work piece W. Accordingly, the uniformity of the heating treatment for the entirety of the work piece W can be improved and the working efficiency of the heating treatment can also be improved corresponding to multiple types of work pieces W.

Embodiments of the present invention are described above; however, the present invention is not limited to the above-described Embodiments and can be implemented by various modifications and alterations based on the technical idea of the present invention.

For example, as a First Modification of the First Embodiment and the Second Embodiment, multiple coils may be disposed at each end of the conveyor 2 in the longitudinal direction of the conveyor 2 at intervals. The same advantageous effects as those of the First Embodiment and the Second Embodiment can be obtained by this Modification.

As a Second Modification of the First Embodiment and the Second Embodiment, the Modification may be configured such that the drive unit 4b is disposed above the conveyor 2, the holding portion 4a is disposed on the lower end of the drive unit 4b, and thereby the work piece W is held in the lower end of the holding portion 4a. The same advantageous effects as those of the First Embodiment and the Second Embodiment can be obtained by this Modification.

### Example

An Example of the present invention will be explained. In the Example, the work piece W was heated by the heating apparatus and the heating method according to the First Embodiment. As the work piece W, a taper bearing type hub unit was used. The time period t1 for conveying the work piece W by the conveyor 2 in one pitch was set at 8 seconds, and the time period t2 for stopping the conveyance of the work piece W among the respective pitches was set at 5 seconds. That is to say, a cycle time period (t1+t2) for one pitch was 13 seconds.

With respect to each of the first heated portions w1 and the second heated portions w2 of the work piece W which had been heated in the above-described manner, the temperature of each of the following temperature measurement regions was measured after the conveyance of the work piece W was completed. Note that the temperature measurement regions are a first temperature measurement region x1, a second temperature measurement region x2, a third temperature measurement region x3, a fourth temperature measurement region x4, and a fifth temperature measurement region x5, and they are regions set by dividing the work piece W into fives vertically from its upper portion to lower portion as shown in FIG. 4A. With respect to each of the first heated portions w1 and the second heated portions w2 of the heated work piece W, the surface hardness of each of the following hardness measurement regions was measured after the conveyance of the work piece W was completed. Note that the hardness measurement regions are a first hardness measurement region z1, a second hardness measurement region z2, a third hardness measurement region z3, a fourth hardness measurement region z4, and a fifth hardness measurement region z5, and they are regions set by dividing the work piece W into fives vertically from its intermediate portion to lower portion as shown in FIG. 4B. With respect to the surface hardness (the Vickers hardness) H of each hardness measurement region, a reference value H0 is 750 Hv, a target lower limit value H1 is 730 Hv, a target upper limit value H2 is 770 Hv, a standard lower limit value H3 is 715 Hv, and a standard upper limit value H4 is 785 Hv. Note that for the surface hardness of each hardness measurement region, values between the target lower limit value H1 and the target upper limit value H2, that is to say, values in the range of 730 Hv to 770 Hv, are tolerable.

### Comparative Example

A Comparative Example of the present invention will be explained. In the Comparative Example, the work piece W was heated in the similar manner as the Example except that the rotation of the work piece was not practiced. In addition, in the Comparative Example, the temperature of the work piece only was measured in the similar manner as the Example.

The results of the temperature measurement in the Example and the Comparative Example described in the following Table 1 were obtained.

TABLE 1

| | | | COMPARATIVE |
|---|---|---|---|
| | TEMPERATURE | EXAMPLE | EXAMPLE |
| HEATED | MEASUREMENT | TEMPERATURE | TEMPERATURE |
| PORTION | REGION | (° C.) | (° C.) |
| FIRST | x1 | 206 | 240 |
| HEATED | x2 | 194 | 230 |
| PORTION | x3 | 192 | 233 |
| w1 | x4 | 194 | 232 |
| | x5 | 196 | 252 |
| SECOND | x1 | 203 | 242 |
| HEATED | x2 | 194 | 231 |
| PORTION | x3 | 195 | 230 |
| w2 | x4 | 195 | 213 |
| | x5 | 210 | 210 |
| | | MAXIMUM | MAXIMUM |
| | | TEMPERATURE | TEMPERATURE |
| | | (° C.) | (° C.) |
| | | 210 | 252 |
| | | MINIMUM | MINIMUM |
| | | TEMPERATURE | TEMPERATURE |
| | | (° C.) | (° C.) |
| | | 192 | 210 |
| | | MAXIMUM | MAXIMUM |
| | | TEMPERATURE- | TEMPERATURE- |
| | | MINIMUM | MINIMUM |
| | | TEMPERATURE | TEMPERATURE |
| | | (° C.) | (° C.) |
| | | 18 | 42 |

Referring to Table 1, in the Example, the difference between the maximum temperature and the minimum temperature among the temperatures of the respective temperature measurement regions x1 to x5 of the first heated portion w1 and the temperature measurement regions x1 to x5 of the second heated portion w2 (hereinafter simply referred to as a “temperature difference in Example”) was 18 degrees C. (° C.). On the other hand, in the Comparative Example, the difference between the maximum temperature and the minimum temperature among the temperatures of the respective temperature measurement regions x1 to x5 of the first heated portion w1 and the temperature measurement regions x1 to x5 of the second heated portion w2 (hereinafter simply referred to as a “temperature difference in Comparative Example”) was 42 degrees C. Therefore, the temperature difference in the Example was smaller than the temperature difference in the Comparative Example, and it was confirmed that the work piece W of the Example had been heated so as to be more uniform than the work piece W of the Comparative Example.

The results of the hardness measurement in the Example shown in FIG. 5 were obtained. In the Example, the surface hardness of each of the hardness measurement regions z1 to z5 in the first heated portion w1 which was shown in the drawing by circular marks, and the surface hardness of each of the measurement regions z1 to z5 in the second heated portion w2 which was shown in the drawing by rectangular marks, were within the tolerance of 730 Hv to 770 Hv. Accordingly, it was confirmed that the work piece W had been sufficiently hardened by the heating treatment of the Example.

### REFERENCE NUMERALS LIST

1 High frequency induction continuous heating apparatus (heating apparatus)
2 Conveyor
2a Conveyance surface
3 High frequency induction heating coil (heating coil)
4 Work piece rotating mechanism
W Work piece
D Arrow
θ Rotation angle (angle)
U Solid line
V Broken line
T Temperature
s Time
s1 Work piece rotation timing
s2 Work piece conveyance end timing
x1 First temperature measurement region
x2 Second temperature measurement region
x3 Third temperature measurement region
x4 Fourth temperature measurement region
x5 Fifth temperature measurement region
z1 First hardness measurement region
z2 Second hardness measurement region
z3 Third hardness measurement region
z4 Fourth hardness measurement region
z5 Fifth hardness measurement region
H Hardness
H0 Reference value
H1 Target lower limit value
H2 Target upper limit value
H3 Standard lower limit value
H4 Standard upper limit value

1. A high frequency induction continuous heating method in which a work piece placed on a conveyance surface of a conveyor is conveyed, and the work piece on the conveyance surface is heated by high frequency induction heating coils which are disposed at both ends of the conveyor in a crosswise direction perpendicular to a conveyance direction, the method comprising a step of:
rotating the work piece around an axis which is extended so as to be perpendicular to the conveyance surface, at a certain rotation angle in mid-flow of conveyance of the work piece so that an orientation of the work piece is changed.

2. The high frequency induction continuous heating method according to claim 1, further comprising steps of:
stopping the conveyance of the work piece before the work piece rotating step; and
resuming the conveyance of the work piece after the work piece rotating step.

3. The high frequency induction continuous heating method according to claim 2, wherein
in the work piece rotating step, the work piece is lifted from the conveyance surface,
the lifted work piece is rotated, and
the rotated work piece is placed on the conveyance surface.

4. The high frequency induction continuous heating method according to claim 3, wherein
in the work piece rotating step, if a rotational center of the rotated work piece has been shifted in a horizontal direction from a reference position which corresponds to the rotational center of the work piece in a state before being lifted, the rotated work piece is moved in the horizontal direction so as to align the rotational center of the rotated work piece with the reference position.

5. The high frequency induction continuous heating method according to claim 1, further comprising a step of:
adjusting the rotation angle of the work piece before the work piece rotating step.

6. A high frequency induction continuous heating apparatus comprising:
a conveyance surface on which a work piece is placed;
a conveyor configured to convey the work piece on the conveyance surface;
high frequency induction heating coils disposed at both ends of the conveyor in a crosswise direction perpendicular to a conveyance direction, and configured to heat the work piece on the conveyance surface; and
a work piece rotating mechanism configured so as to rotate the work piece around an axis which is extended so as to be perpendicular to the conveyance surface, at a certain rotation angle in mid-flow of conveyance of the work piece so that an orientation of the work piece is changed.

7. The high frequency induction continuous heating apparatus according to claim 6, wherein
after the work piece is rotated by the work piece rotating mechanism in a state in which the conveyance of the work piece has been stopped, the conveyance of the rotated work piece is resumed.

8. The high frequency induction continuous heating apparatus according to claim 7, wherein
the work piece rotating mechanism is configured so as to lift the work piece from the conveyance surface, rotate the lifted work piece, and place the rotated work piece on the conveyance surface.

9. The high frequency induction continuous heating apparatus according to claim 8, wherein
the work piece rotating mechanism is configured such that if a rotational center of the rotated work piece has been shifted in a horizontal direction from a reference position which corresponds to the rotational center of the work piece in a state before being lifted, the rotated work piece is moved in the horizontal direction so as to align the rotational center of the rotated work piece with the reference position.

10. The high frequency induction continuous heating apparatus according to claim 6, wherein
the work piece rotating mechanism is configured so as to be capable of adjusting the rotation angle of the work piece.

11. The high frequency induction continuous heating method according to claim 2, further comprising a step of:
adjusting the rotation angle of the work piece before the work piece rotating step.

12. The high frequency induction continuous heating method according to claim 3, further comprising a step of:
adjusting the rotation angle of the work piece before the work piece rotating step.

13. The high frequency induction continuous heating method according to claim 4, further comprising a step of:
adjusting the rotation angle of the work piece before the work piece rotating step.

14. The high frequency induction continuous heating apparatus according to claim 7, wherein
the work piece rotating mechanism is configured so as to be capable of adjusting the rotation angle of the work piece.

15. The high frequency induction continuous heating apparatus according to claim 8, wherein
the work piece rotating mechanism is configured so as to be capable of adjusting the rotation angle of the work piece.

16. The high frequency induction continuous heating apparatus according to claim 9, wherein
the work piece rotating mechanism is configured so as to be capable of adjusting the rotation angle of the work piece.
